(19) United States
(12) Patent Application Publication
(10) Pub. No.: US 2014/0135061 A1
(43) Pub. Date: May 15, 2014

(54) APPARATUS AND METHOD FOR SHARING ANTENNA

(71) Applicant: BROADCOM CORPORATION, Irvine, CA (US)

(72) Inventors: Seppo Olavi ROUSU, Oulu (FI); Olavi Yrjo KAIPAINEN, Espoo (FI)

(73) Assignee: BROADCOM CORPORATION, Irvine, CA (US)

(21) Appl. No.: 14/077,317

(22) Filed: Nov. 12, 2013

(30) Foreign Application Priority Data
Nov. 12, 2012 (GB) 1220323.8

(51) Int. Cl. H04B 1/40; H04W 88/06

(52) U.S. Cl. CPC H04B 1/401; H04W 88/06
USPC 455/553.1

(57) ABSTRACT

An apparatus and method for sharing antenna allow an antenna to be shared simultaneously by two modems and a reduction in antenna count. The apparatus includes a first modem and a second modem and a switch system is arranged to selectively connect one of the first and second modems to a first antenna and selectively connect one of the first and second modems to a second antenna. A pass through output is associated with the first modem and arranged to selectively output at least a portion of a received signal to the second modem. The pass through output allows some or all of the received signal to be passed on to the second modem, so both modems can share same antenna at the same time.

### CROSS REFERENCE TO RELATED APPLICATION

This application claims the benefit under 35 U.S.C. §119(a) and 37 CFR §1.55 to UK Patent Application No. 1220323.8, filed on Nov. 12, 2012, the entire content of which is incorporated herein by reference.

### TECHNICAL FIELD

The present invention relates to an apparatus and method which allow an antenna to be shared by more than one modem.

### BACKGROUND INFORMATION

There is a requirement to include more than one modem in devices. For example, more than one modem may be required to allow a device to communicate using different wireless standards. Each modem may require more than one antenna in order for example to allow it to communicate in a diversity mode, carrier aggregation mode, multi SIM mode or multiple input multiple output mode. The combination of these requirements creates a need for ever more antennas.

Systems in which antennas can be switched between modems for different wireless communication systems are suggested in US2011/0025096A1 and WO2011/042051A1. Such systems switch an antenna to a single modem and therefore require a minimum number of antennas dictated by the number of modems that may be used simultaneously. For example, if there are two modems that can be used simultaneously and each requires two antennas, then four antennas must be provided.

US2007/0129104A1 (Sano et al.) discusses a wireless communication apparatus in which an antenna can be shared simultaneously between a Bluetooth and a Wireless LAN communication unit. A shared antenna is connected through a Wilkinson Power Splitter or a directional coupler. The Wilkinson Power Splitter or directional coupler shares received signal power equally between the wireless LAN and the Bluetooth and provide an isolation characteristic between the wireless LAN and Bluetooth. The use of the Wilkinson Power Splitter or Coupler introduces a large loss into the signal path, at least 3 dB due to the division of power between ports.

### SUMMARY

In accordance with one exemplary embodiment of the present invention, there is provided an apparatus which includes a first modem and a second modem. A switch system is arranged to selectively connect one of the first and second modems to a first antenna and selectively connect one of the first and second modems to a second antenna. A pass through output is associated with the first modem and arranged to selectively output at least a portion of a received signal to the second modem.

In accordance with another exemplary embodiment of the present invention, there is provided a method of sharing a first antenna and a second antenna between a first modem and a second modem. The method includes:

connecting the first antenna to the first modem when the first modem is in operation, otherwise connecting the first antenna to the second modem;

connecting the second antenna to the second modem when the second modem is in operation, otherwise connecting the second antenna to the first modem; and

selectively passing at least a portion of a signal received at the first antenna to the second modem through a pass through arrangement associated with the first modem, when the first antenna is connected to the first modem.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a schematic representation of a wireless communication between counterparts;

FIG. 2 is a diagrammatic representation of a first embodiment;

FIG. 3 is a diagrammatic representation of signal paths in the embodiment of FIG. 2 when only the first modem is operational;

FIG. 4 is a diagrammatic representation of signal paths in the embodiment of FIG. 2 when only the second modem is operational;

FIG. 5 is a diagrammatic representation of signal paths in the embodiment of FIG. 2 when both first and second modems are operational using a single antenna;

FIG. 6 is a diagrammatic representation of signal paths in the embodiment of FIG. 2 when both the first and second modems are operational and the first modem is sharing the second antenna with the second modem;

FIG. 7 is a diagrammatic representation of alternative signal paths in the embodiment of FIG. 2 when both the first and second modems are operational and the first modem is sharing the second antenna with the second modem;

FIG. 8 is a diagrammatic representation of signal paths in the embodiment of FIG. 2 when both the first and second modems are operational and the second modem is sharing the first antenna with the first modem;

FIG. 9 is a diagrammatic representation of alternative signal paths in the embodiment of FIG. 2 when both the first and second modems are operational and the second modem is sharing the first antenna with the first modem;

FIG. 10 is a diagrammatic representation of signal paths in the embodiment of FIG. 2 when both the first and second modems are operational and the first modem is sharing the first and second antennas with the second modem;

FIG. 11 is a diagrammatic representation of alternative signal paths in the embodiment of FIG. 2 when both the first and second modems are operational and the first modem is sharing the first and second antennas with the second modem;

FIG. 12 is a diagrammatic representation of a further embodiment;

FIGS. 13 and 14 are flow charts depicting process flows for controlling a switch system in the embodiment of FIG. 2; and

FIG. 15 is a flow chart depicting process flows to control a pass through switch.

### DETAILED DESCRIPTION

In one exemplary embodiment of the present invention, there is provided an apparatus which includes a first modem and a second modem. A switch system is arranged to selectively connect one of the first and second modems to a first antenna and selectively connect one of the first and second modems to a second antenna A pass through output is associated with the first modem and arranged to selectively output at least a portion of a received signal to the second modem. The pass through output allows an antenna connected to the first modem to be shared simultaneously with one or more other modems. As a further advantage it adds relatively little insertion loss into the signal. This embodiment is not limited to only first and second modems and first and second antennas. Other embodiments may have more than two modems and more than two antennas. Further embodiments may have one or more subscriber identification modules in use, for example SIM or USIM, which may be used for positioning, data and voice communication purposes.

The switch system can be arranged to connect the pass through output associated with the first modem to the second modem when the first modem is connected to a said first antenna. This ensures that the pass through output of the first modem is available to the second modem if required. The arrangement can also ensure that the switch system and the pass through output of the first modem make at least a portion of a received signal at the first antenna to be available for the second modem, when the first antenna is connected to the first modem and when such portion of the received signal at the first antenna is required/needed at the second modem.

A pass through output associated with the second modem can also be provided and arranged to selectively output at least a portion of a received signal to the first modem. This allows an antenna connected to the second modem to be shared simultaneously with one or more other modems. The switch system can then be arranged to connect the pass through output associated with the second modem to the first modem when the second modem is connected to a said first antenna. This ensures that the pass through output of the second modem is available to the first modem if required. The arrangement can also ensure that the switch system and the pass through output of the second modem make at least a portion of a received signal at the second antenna to be available for the first modem, when the second antenna is connected to the second modem and when such portion of the received signal at the second antenna is required at the first modem.

The first modem can include a higher frequency input/output and a lower frequency input/output. The apparatus then includes a frequency selective component with a higher frequency port connected to the higher frequency input/output, a lower frequency port connected to the lower frequency input/output and a common port arranged to be selectively connected to a said first antenna, thereby to provide a single input/output to both the higher frequency input/output and the lower frequency input/output. The frequency selective component can split and/or combine signals as necessary with minimal insertion loss. In some embodiments the frequency selective component can be a diplexer, a triplexer or a quadplexer it can also be implemented from discrete components.

The pass through output associated with the first modem can include a higher frequency output and a lower frequency output. The apparatus then includes a frequency selective component with a higher frequency port connected to the higher frequency output, a lower frequency port connected to the lower frequency output and a common port arranged to be selectively connected to the second modem, thereby to provide a single output for both the higher frequency output and the lower frequency output.

The second modem can include a higher frequency input/output and a lower frequency input/output. The apparatus then includes a frequency selective component with a higher frequency port connected to the higher frequency input/output, a lower frequency port connected to the lower frequency input/output and a common port arranged to be selectively connected to a said second antenna, thereby to provide a single input/output to both the higher frequency input/output and the lower frequency input/output.

The pass through output associated with the second modem can include a higher frequency output and a lower frequency output. The apparatus then includes a frequency selective component with a higher frequency port connected to the higher frequency output, a lower frequency port connected to the lower frequency output and a common port arranged to be selectively connected to the first modem, thereby to provide a single output for both the higher frequency output and the lower frequency output.

The first modem can include a primary portion and a secondary portion, and the second modem can also include a primary portion and a secondary portion. The switch system is then arranged to selectively connect the primary portion of the first modem or the secondary portion of the second modem to a said first antenna and selectively connect the primary portion of the second modem or the secondary portion of the first modem to a said second antenna. The primary and secondary portions can use different antennas for operation in some modes, for example in diversity, carrier aggregation and MIMO modes.

The pass through output associated with the first modem can be arranged to selectively output at least a portion of a received signal to the secondary portion of the second modem. The pass through output associated with the second modem can be arranged to selectively output at least a portion of a received signal to the secondary portion of the first modem. Therefore the effects of any signal losses from being passed a signal via a pass through output of another modem effect the secondary portion rather than the primary portion.

A controller can be provided which is configured to operate the switching system to: connect the first modem to a said first antenna when the first modem is in operation, and otherwise connect the second modem to the said first antenna; and connect the second modem to a said second antenna when the second modem is in operation, and otherwise connect the first modem to the said second antenna. This is simple to implement and enables each modem to have one antenna connected to it without the signal for the one antenna needing to travel via another modem's pass through. If that antenna is then used for transmission, signal losses in the transmission path are reduced.

A controller can be configured to activate or deactivate the pass through output associated with the first modem dependent upon data of the operation state of the second modem. For example the pass through output may only be activated when the second modem is operational. The controller can be configured to activate or deactivate the pass through output associated with the first modem dependent upon data of the operation state of the first modem. For example the pass through output can be deactivated when the first modem is transmitting to avoid leakage from the transmission being passed to the second modem. For the same reasons, a controller can also be configured to activate or deactivate the pass through output associated with the second modem dependent upon data of the operation state of the first modem and possibly configured to activate or deactivate the pass through output of the second modem dependent upon data of the operation state of the second modem.

The apparatus can be part of a mobile device, for example a commercial electronic device, a public safety device, a vehicle or a mobile telephone. The mobile device can include a first antenna and a second antenna.

In other exemplary embodiments, the apparatus can consist of two modems for connection to two antennas and a switching network. In further exemplary embodiments, the apparatus consists of exactly two modems and a switching network together with other components, such as diplexers, described above. If antennas are provided in such embodiments, there are exactly two antennas.

In another exemplary embodiment a method of sharing a first antenna and a second antenna between a first modem and a second modem includes:

connecting the first antenna to the first modem when the first modem is in operation, otherwise connecting the first antenna to the second modem;

connecting the second antenna to the second modem when the second modem is in operation, otherwise connecting the second antenna to the first modem; and

selectively passing at least a portion of a signal received at the first antenna to the second modem through a pass through arrangement associated with the first modem, when the first antenna is connected to the first modem.

This provides a simple implementation that allows an antenna to be shared simultaneously.

The method can also include passing at least a portion of a signal received at the second antenna to the first modem through a pass through arrangement associated with the second modem, when the second antenna is connected to the second modem.

The passing at least a portion of a signal received at the first antenna to the second modem can be dependent upon an operation state of the first modem and the second modem. The passing at least a portion of a signal received at the second modem to the first modem can be dependent upon an operation state of the first modem and the second modem. This allows the pass through to only be activated when required and avoid leakage to the other modem when one of the modems is transmitting.

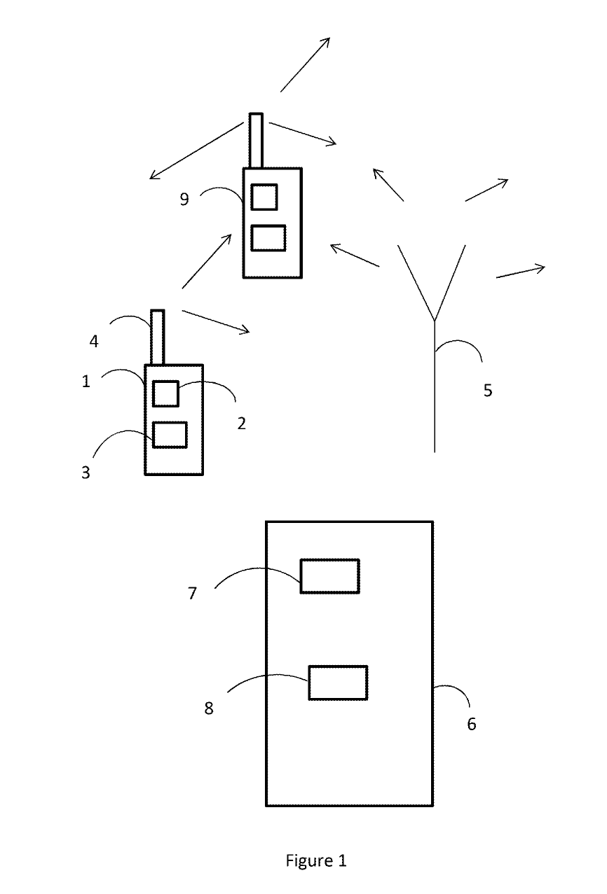

FIG. 1 shows schematically a wireless network within which embodiments of the invention may function. A user equipment (“UE”) or wireless device, in this case in the form of a mobile phone/smartphone 1, contains the necessary radio module 2, processor(s) and memory/memories 3, antenna 4, etc. to enable wireless communication with the network. The user equipment 1 in use is in communication with a radio mast 5, which forms part of a base station, and/or communication counterpart as alternate UE 9. As a particular example in the context of UMTS (Universal Mobile Telecommunications System), there may be a network control apparatus 6 (which may be constituted by for example a so-called Radio Network Controller) operating in conjunction with one or more Node Bs (which, in many respects, can be regarded as “base stations”). As another example, LTE (Long Term Evolution) makes use of a so-called evolved Node B (eNB) where the RF transceiver and resource management/control functions are combined into a single entity. The term “base station” is used in this specification to include a “traditional” base station, a Node B, an evolved Node B (eNB), or any other access point to a network, unless the context requires otherwise. The network control apparatus 6 (of whatever type) may have its own processor(s) 7 and memory/memories 8, etc. In some embodiments the network control apparatus may communicate with a UE via two or more cell masts.

Although the wireless network above is described in the context of a mobile phone, embodiments of the invention can be applied any wireless network, including Wireless LAN, such as defined by the IEEE 802.11 family of standards, Bluetooth and WiMAX, such as defined by IEEE 802.16 family of standards, and to other wireless devices.

Mobile devices include mobile or cell phones (including so-called “smart phones”), personal digital assistants, pagers, tablet and laptop computers, content-consumption or generation devices (for music and/or video for example), data cards, USB dongles or other types of communication modules etc. Mobile devices may also include larger apparatus, such as vehicles, including but not limited to cars, buses, coaches, heavy goods vehicles, trains and aeroplanes, or the mobile devices may be inserted in or attached to any of such devices.

Cellular wireless networks, for example as shown schematically in FIG. 1 for communication between the UE 1,9 and radio mast or base station 5, typically include user equipment (UE) such as mobile handsets or other wireless devices which may communicate via a network interface including a radio transceiver to a network of base stations connected to a telecommunications network. Such cellular wireless networks have undergone rapid development through a number of generations of radio access technology. The initial deployment of systems using analogue modulation has been superseded by second generation (2G) digital systems such as GSM (Global System for Mobile communications), implementing GERAN (GSM Enhanced Data rates for GSM Evolution Radio Access Network) radio access networks, and these systems have themselves been replaced by or augmented by third generation (3G) digital systems such as UMTS (Universal Mobile Telecommunications System), implementing the UTRAN (Universal Terrestrial Radio Access Network) radio access networks. Third generation standards provide for a greater throughput of data than is provided by second generation systems; this trend is continued with the introduction of High Speed Packet Access (HSPA), which may augment third generation systems, providing a high capacity packet switched downlink. HSPA typically uses adaptive modulation and coding to provide increased capacity when a channel has a good quality, for example a high signal to noise ratio. In a system such as HSPA using adaptive modulation and coding, a succession of Channel Quality Indicators (CQIs) is typically fed back from a receiver, typically at a user equipment, to a serving node for use in determining a transmission format, which may include a type of modulation and a type of coding, for use on a downlink from the node to the user equipment.

In other embodiments communication may be direct from one UE to another UE, for example directly between UE 1 and UE 9. Examples of direct communications include peer-to-peer wireless networks, such as a wireless network according to one of the IEEE 802.11 standards operating in ad-hoc mode.

Multiple transmitter schemes, such as MIMO (multiple input, multiple output) and MIXO (multiple input, any output) have been proposed for use with HSPA and other wireless transmission formats. A multiple transmitter scheme may use multiple transmit antennas to provide a number of transmission streams, one or more or all of which may be received at a given user equipment, providing potentially greater capacity than a single transmitter scheme. A transmission stream may correspond to a transmitted beam, and may be referred to as a layer, and beams may overlap spatially. Multiple transmitter schemes may be used as part of a transmission format using adaptive modulation and coding, for example in a HSPA system.

Existing HSPA systems can be specified for use with a multiple transmitter communications link, such as a MIMO (multiple input, multiple output) or MIXO (multiple input, single or multiple output) scheme. For example, a MIMO scheme has been specified using two antennas at the base station to provide two transmission streams, which may be referred to as layers or components, and which may be beamformed spatial beams. The beams may overlap in space, so that one or both of the beams may be received at a user equipment, and if both are received, this may be used to provide additional data capacity compared to the capacity of a single beam. In addition, adaptive modulation and coding may be used, and so, depending on channel quality, there are a variety of possible configurations of the downlink in terms of number of transmission streams and modulation and coding formats. Such MIMO and MIXO schemes are not limited to HSPA and can also be used in other wireless communication systems, for example wireless networking according to the IEEE 802.11 standards

MIMO and MIXO require multiple antennas to support the different transmission streams. Systems which combine multiple, different transmission streams at different frequencies are sometimes referred to as carrier aggregation.

Other systems also require multiple antennas. Examples include diversity systems such as antenna diversity systems and carrier diversity systems. In an antenna diversity system, transmission streams are transmitted from different antennas and/or received by different antennas, to counteract interference and fading. The antennas can be located on different cell towers. In a carrier diversity system, transmission streams are transmitted on different carriers, for example at different frequencies, to counteract interference and fading and/or increase channel capacity.

As noted above, the development of wireless devices is progressing towards systems which require multiple antennas to support increased data throughput and/or more reliable communication channels. There is also an increasing requirement for wireless devices to support more than one wireless communication system. For example the wireless device may support some or all of GSM, UMTS, LTE, WiFi, WiMAX and Bluetooth. Each of these may require two or more antennas. More than one of these wireless communication systems may be active at the same time. For example, the UMTS, WiFi and Bluetooth systems may all be active simultaneously. This creates a design challenge to fit the required number of antennas into the wireless device. The design problem remains even with larger mobile devices, such as cars, because the number of possible antenna sites is small and complex wire routes may be required.

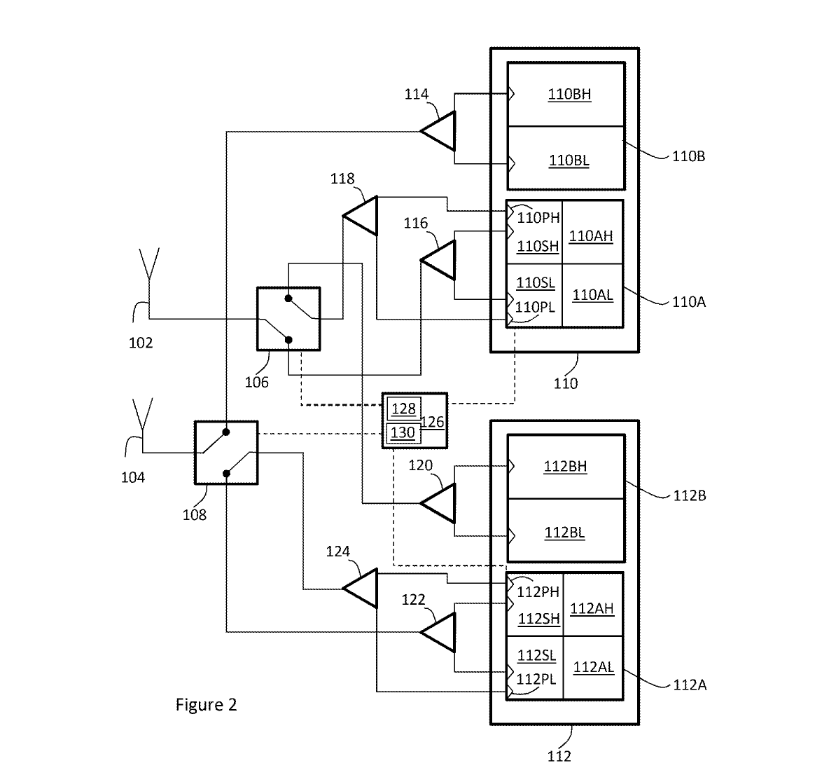

An example of an embodiment of the present invention is shown in diagrammatic form in FIG. 2. In this embodiment two antennas can be shared simultaneously by two modems with relatively small additional losses introduced into the signal path and no additional losses if an antenna is not shared.

A wireless device can be connected to or includes a first antenna 102 and a second antenna 104. For example, if the wireless device is a car or other automobile such as a truck or train, etc., or is mounted in or on a car or other automobile, the first antenna 102 can be incorporated into a side mirror and the second antenna 104 may be provided in the other side mirror or on the car roof, or first and second antennas 102, 104 may be mounted in a single unit, such as a so-called shark fin antenna mount on a vehicle roof. In another example, if the wireless device is a mobile telephone, the first antenna 102 and the second antenna 104 can be provided at different positions within or outside a housing of the mobile telephone. In other embodiments further configurations of two antennas can be provided, depending on the form of the wireless device where the embodiment is implemented. In yet further embodiments the wireless device may be connected to the first antenna 102 and the second antenna 104. For example an in-vehicle preparation for a mobile telephone may include antennas for connection to the mobile telephone. Antennas can also be provided as part of or for connection to vehicle telematics, an automatic wireless emergency notification system such as the eCall system proposed by the European Union, or an in-vehicle entertainment system.

In alternative embodiments the antenna configuration may be different than shown in figures. For example, an increased antenna count may be required, such as three, four or more antennas. This may be required, for example, due to the operational frequencies of antennas, isolation required between antennas and the number of operational radios.

A switch system is arranged to allow selective connection of the first antenna 102 and the second antenna 104 to either of a first modem 110 and a second modem 112. Each modem includes at least one pass through output which can be selectively activated to pass through at least a portion of a received signal to the other modem, described in more detail below.

Each modem includes a primary portion 110A, 112A and a secondary portion 110B, 112B. When operating in a diversity, carrier aggregation or MIMO mode the primary and secondary portions are each connected to a different antenna.

The primary and secondary portions of each modem includes a higher frequency portion 110AH, 110BH, 112AH, 112BH and a lower frequency portion 110AL, 110BL, 112AL, 112BL. The modems use the higher and lower frequency portions depending on their operating mode and frequency of operation. The primary portion of each modem also further includes a pass through output which can be selectively activated to pass through at least a portion of a received signal to the other modem. In this embodiment the pass through output is an integral part of the modem. There are two pass through outputs for each modem (one for the higher frequency portion and one for the lower frequency portion) and each pass through output 110PL, 110PH, 112PL, 112PH is provided as part of a TRX Switch 110SH, 110SL, 112SH, 112SL. In other embodiments the pass through output can be separate from the modem. The construction of the modems is known to the skilled person.

Diplexers 114, 116, 118, 120, 122, 124 are frequency selective components provided to split a signal into higher frequency and lower frequency components or to combine higher frequency and lower frequency components into a single signal. Each diplexer includes a common port, a high port and a low port and is connected to a higher and lower frequency input and/or output to the modems. A diplexer is a passive device with reciprocal operation. A low pass filter is connected between the common port and the low port. A high pass filter is connected between the common port and the high port. The frequency cut off depends on the design of the filters. The choice of the frequencies varies depending on the frequencies used in the communication system. For example, a diplexer may have pass band of 1 GHz and 2 GHz range cellular frequencies. Further embodiments may use other frequency selective components in place of the diplexers. Examples include a triplexer or quadplexer.

In this embodiment the switch system includes first switch 106 and second switch 108. Both the first switch 106 and the second switch 108 have four terminals and have two possible states. In a first state, the first and second terminals are connected to each other and the third and fourth terminals are connected to each other (this is depicted for first switch 106 in FIG. 2). In a second state the first and fourth terminals are connected to each other and the second and third terminals are connected to each other (this is depicted for second switch 108 in FIG. 2). Switches that operate in this way may be referred to as “intermediate” or “four-way” switches. Such a switch can be constructed from a double pole double throw switch or from two single pole double throw switches.

The first switch 106 has its terminals connected as follows. The first terminal is connected to the first antenna 102. The second terminal is connected via a diplexer 116 to an input/output of the higher and lower frequency portions of primary portion 110A of the first modem 110. The third terminal is connected via a diplexer 118 to the pass through outputs 110PL, 110PH of the higher and lower frequency portions of the primary portion 110A of the first modem 110. The fourth terminal is connected via a diplexer 120 to the higher and lower frequency portions of the secondary portion 112B of the second modem 112.

The second switch 108 has its terminals connected as follows. The first terminal is connected to the second antenna 104. The second terminal is connected via a diplexer 122 to an input/output of the higher and lower frequency portions of primary portion 112A of the second modem 112. The third terminal is connected via a diplexer 124 to the pass through outputs 112PL, 112PH of the higher and lower frequency portions of the primary portion 112A of the second modem 112. The fourth terminal is connected via a diplexer 114 to the higher and lower frequency portions of the secondary portion 110B of the first modem 110.

When the first switch 106 is in the first state, the first antenna 102 is connected to the first modem 110, more specifically to the primary portion 110A of the first modem 110, and the pass through outputs 110PL, 110PH from the first modem 110 are connected with the second modem 112, more specifically to the secondary portion 112B of the second modem 112. Likewise, when the second switch 108 is in the first state, the second antenna 104 is connected with the second modem 112, more specifically to the primary portion 112A of the second modem 112, and the pass through outputs 112PL, 112PH from the second modem 112 are connected with the first modem 110, more specifically the secondary portion 110B of the first modem 110.

When the first switch 106 is in the second state, the first antenna 102 is connected to the second modem 112, more specifically to the secondary portion 112B of the second modem 112. The pass through outputs 110PL, 110PH of the first modem 110 are also connected back to the inputs of the first modem 110, more specifically to the primary portion 110A of the first modem 110. Likewise, when the second switch 108 is in the second state, the second antenna 104 is connected to the first modem 110, more specifically to the secondary portion 110B of the first modem 110. The pass through outputs 112PL, 112PH of the second modem 112 are also connected back to the inputs of the second modem 112, more specifically to the primary portion 112A of the second modem 112.

A controller 126 controls the switch system and activation/deactivation of the pass through outputs. A simple embodiment of the pass through output includes a switching arrangement, where the controller 126 controls the switching arrangement to enable/disable the signal(s) to pass through. The controller 126 includes a processor 128 and memory 130 storing instructions for execution by the processor 128. Control connections, shown as dashed lines in FIG. 2, are provided to exchange data and commands with the first switch 106, second switch 108, switches 110SH, 110SL associated with the pass through outputs 110PL, 110PH of the first modem and switches 112SH and 112SL associated with the pass through outputs 112PL, 112PH of the second modem 112. The controller 126 operates to control the switch system and pass through outputs 110PL, 110PH, 112PL, 112PH depending on the operation mode of the first and second modems. In some modes the pass through outputs 110PL, 110PH, 112PL, 112PH may be further controlled depending on whether the first and second modems are transmitting data. In alternative embodiments the controller can be integrated into one or both of the first modem 110 and the second modem 112. In embodiments with a controller integrated into both modems the controller in one modem can be designated as a master and the controller in the other modem as a slave. In some embodiments the controller can control reception algorithm, transmission algorithm, and reporting accuracy to its communication counterpart (for example a base station or another UE) taking account of actual signal path losses and phase changes of signals.

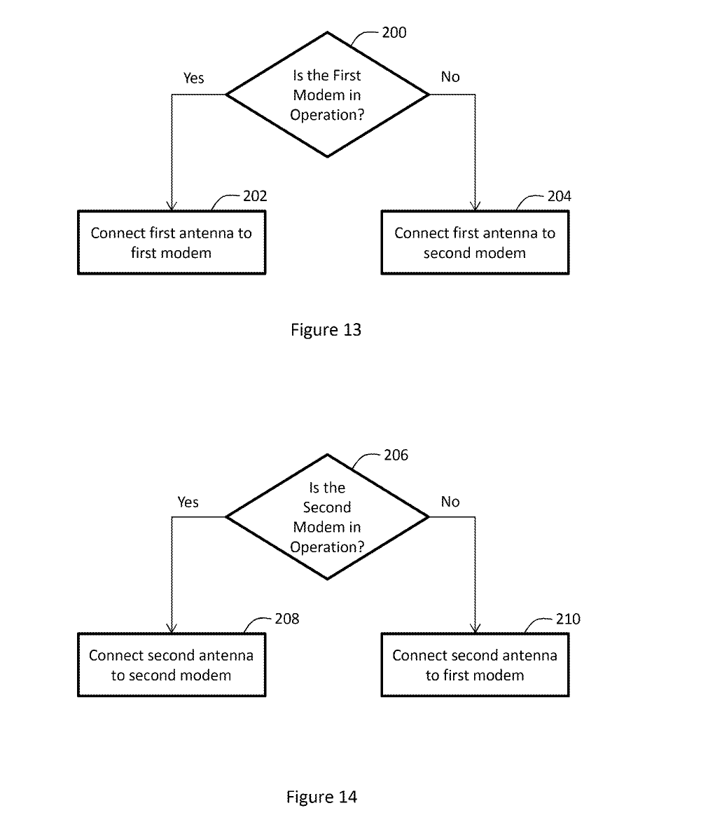

The controller 126 is configured to control the switch system according to the following rules, depicted in FIGS. 13 and 14. If the first modem 110 is in operation (step 200 in FIG. 13), activate the switch 106 to be in the first state so that the first antenna is connected to the first modem (step 202 in FIG. 13), otherwise activate the first switch 106 to be in the second state so that the first antenna is connected to the second modem (step 204 in FIG. 13). In general, a modem is in operation if it has power applied and is capable of receiving and/or transmitting data, but does not have to be receiving and/or transmitting data. If the second modem 112 is operation (step 206 in FIG. 14), activate the second switch 108 to be in the first state so that the second antenna 104 is connected to the second modem 112 (step 208 in FIG. 14), otherwise activate the second switch 108 to be in the second state so that the second antenna 104 is connected to the first modem 110 (step 210 in FIG. 14). The processes of FIGS. 13 and 14 can be run sequentially or in parallel because they are independent of each other.

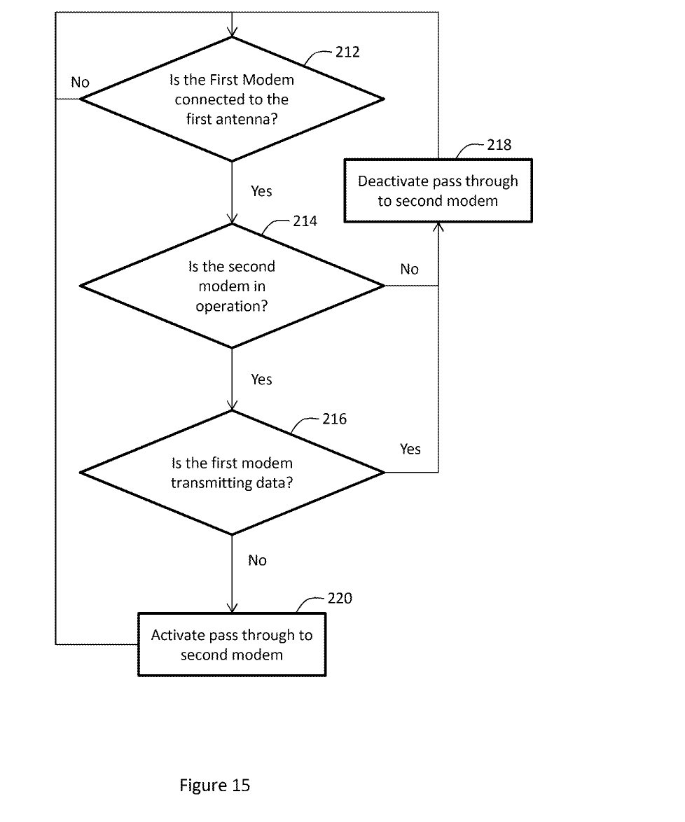

Pass through outputs 110PL, 110PH of the first modem can be controlled by configuring the controller 126 to activate or deactivate the pass through output of switch 110SL, 110SH according to the process in the flow chart of FIG. 15. This process is described for control of the first modem's pass through outputs 110PL, 110PH of switches 10SL, 110SH but the same method can be used for the second modem's pass through outputs 112PL, 112PH of switches 112SL, 112SH. First, at step 212, it is determined whether the first modem 110 is connected to the first antenna 104, if it is execution proceeds to step 214, if not the process loops and step 212 is repeated.

At step 214, it is determined whether the second modem 112 is in operation, if it is execution proceeds to step 216, otherwise the pass through outputs 110PL, 110PH are deactivated at step 218 (or they are maintained as deactivated if they are already deactivated) and execution returns to step 212.

At step 216, it is determined whether the first modem 110 is transmitting data. If it is execution proceeds to step 218 and the pass through outputs 110PL, 110PH are deactivated, otherwise execution proceeds to step 220 and an appropriate pass through output 110PH, 110PL is activated. The appropriate output can be determined with reference to the operating mode of the first modem 110 and activating the pass through output 110PL, 110PH associated with the frequencies not in use by the first modem. For example, if the first modem is operating with lower frequency signals, the pass through output 110PH of switch 110SH is activated to pass through higher frequency signals. In alternative embodiments the appropriate pass through output 110PH, 110PL can be determined with reference to the operating of the second modem 112 and activating the pass through output associated with the frequencies in use by the second modem 112.

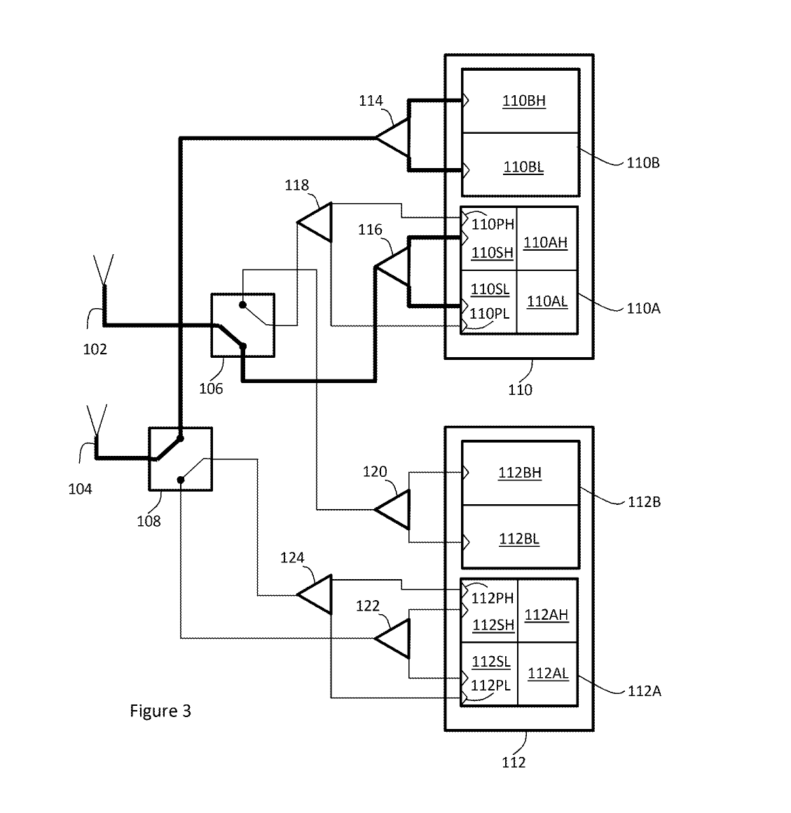

The result of this control logic and further details of the control implemented by controller 126 to activate and deactivate the pass through outputs 110PL, 110PH, 112PL, 112PH will now be described with reference to FIGS. 3-11. FIGS. 3-11 show the signal paths dependent on the operation mode of the first modem and the second modem. The controller 126 is not shown in FIGS. 3-11 for clarity.

FIG. 3 is a diagrammatic representation of signal paths when only the first modem 110 is operating. The controller 126 therefore sets the first switch 106 to the first state and the second switch 108 to the second state. This connects the first antenna 102 to the primary portion 110A of the first modem 110. Both the higher and lower frequency portions of the primary portion 110A can be in operation for transmission and reception. The second antenna 104 is connected to the secondary portion 110B of the first modem 110 and both the higher and lower frequency portions are available for reception. The first modem 110 can therefore operate in a diversity mode or carrier aggregation mode as desired. Using the information that only the first modem 110 is operating, the controller also deactivates the pass through outputs 110PL, 110PH of switches 110SL, 110SH of the first modem 110.

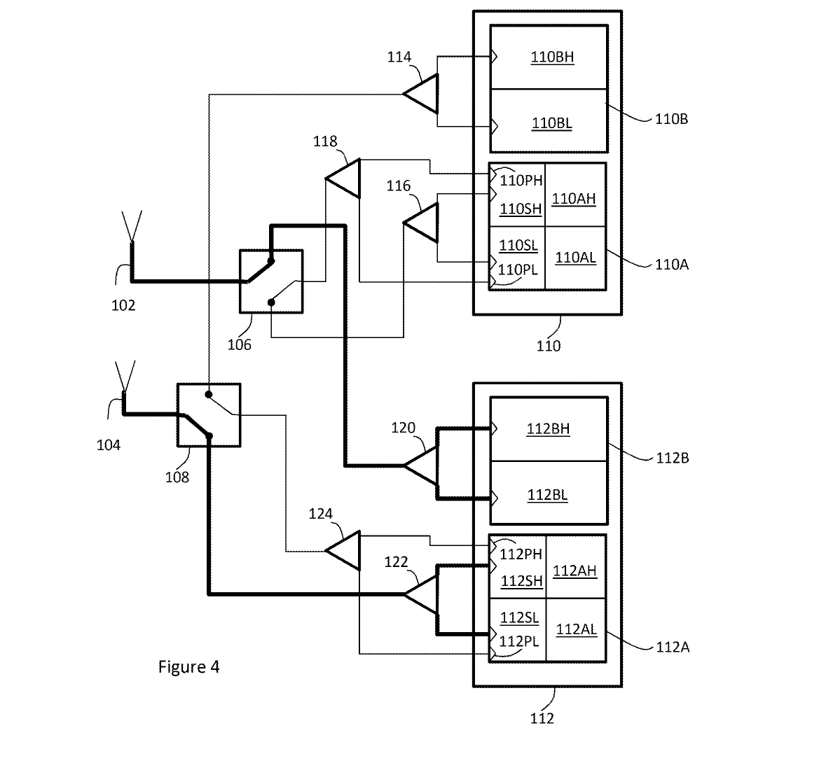

FIG. 4 is a diagrammatic representation of signal paths when only the second modem 112 is operating. The controller 126 therefore sets the first switch 106 to the second state and the second switch 108 to the first state. This connects the first antenna 102 to the secondary portion 112B of the second modem 112. Both the higher and the lower frequency portions are available for reception. The second antenna 104 is connected to the primary portion 112A of the second modem 112 and both the higher and lower frequency portions are available for reception and transmission. The second modem 112 can therefore operate in a diversity mode or a carrier aggregation mode as desired. Using the information that only the second modem 112 is operating, the controller also deactivates the pass through outputs 112PL, 112PH of switches 112SL, 112SH of the second modem 112.

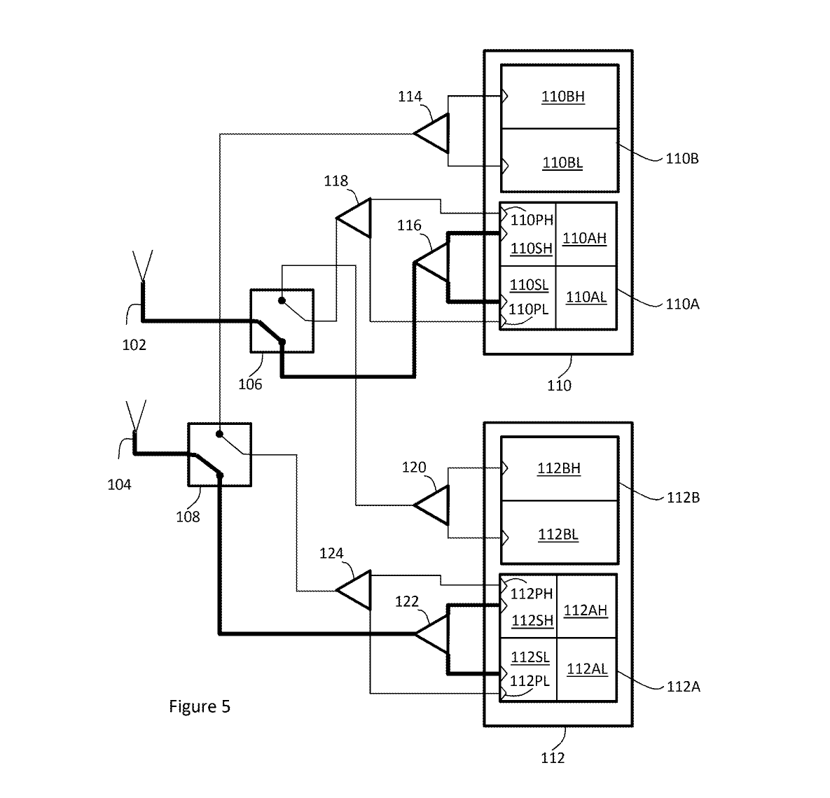

In the operational cases of FIGS. 5 to 11 both the first modem 110 and second modem 112 are operational. The controller 126 therefore sets the first switch 106 to the first state and the second switch 108 to the first state. This connects the first antenna 102 to the primary portion 110A of the first modem 110. The second antenna 104 is connected to the primary portion 112A of the second modem 112. The status of the pass through outputs 110PL, 110PH, 112PL, 112PH of switches 110SL, 100SH, 112SL, 112SH and other operational parameters will be described below in more detail.

FIG. 5 is a diagrammatic representation of the signal paths when both first and second modems 110,112 are operational and each is using a single antenna. Neither the first antenna 102 nor the second antenna 104 is shared so the primary portions IIOA, 112A of the first and second modems 110,112 can use both the higher and lower frequency portions for reception and transmission as required. The first and second modems 110,112 can both operate without diversity or carrier aggregation using a single antenna. Using information that both modems 110,112 are using a single antenna, the controller 126 disables the pass through outputs 110PL, 110PH, 112PL, 112PH of switches 110SL, 110SH, 112SL, 112SH of both modems 110, 112.

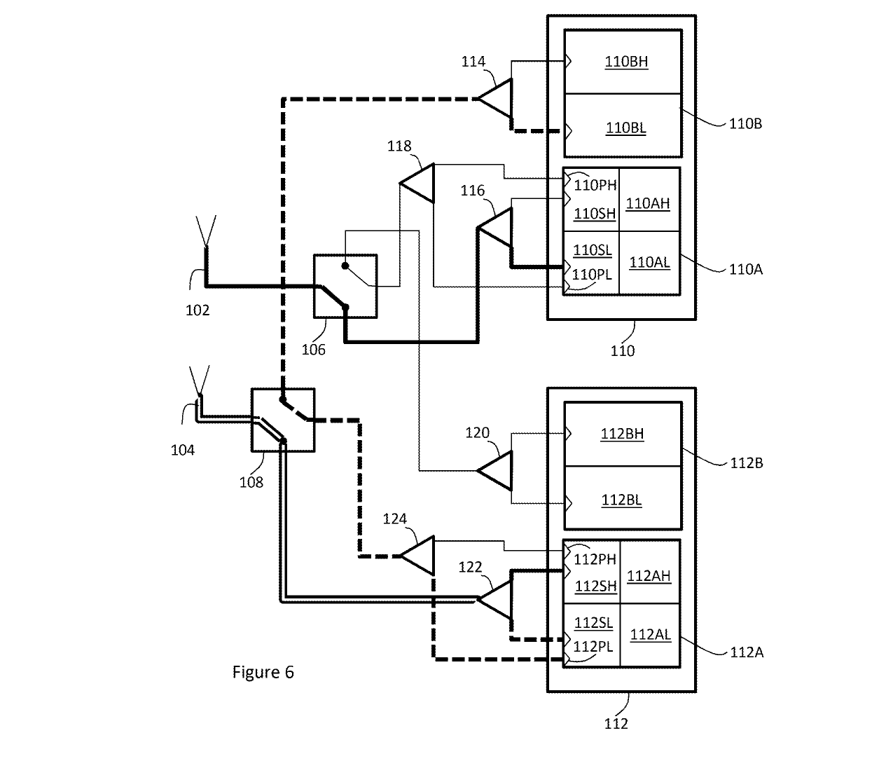

FIG. 6 is a diagrammatic representation of signal paths when both the first and second modems 110,112 are operational and the first modem 110 is sharing the second antenna with the second modem 112. The second antenna 104 is shared so that lower frequency signals are used by the first modem 110 and higher frequency signals are used by the second modem 112. Separation of the signals from the second antenna 104 into higher and lower frequency signals is carried out by the diplexer 122. The controller 126 activates the pass through output 112PL in switch 112SL of the lower frequency portion 112AL of the primary portion 112A of the second modem 112. The pass through output 112PL from the switch 112SL is routed via diplexer 124, switch 108 and diplexer 114 to the lower frequency portion 110BL of the secondary portion 110B of the first modem 110. The first modem 110 can therefore operate in for example a diversity mode using lower frequency signals and the second modem 112 can operate without diversity using higher frequency signals.

In some embodiments the controller 126 may deactivate the pass through output 112PL of switch 112SL when the second modem 112 is transmitting. The reciprocal nature of the diplexer 122 means that some of the transmitted signal may leak from the higher frequency port to the lower frequency port. Deactivating the pass through when the second modem 112 is transmitting avoids any leakage being directed to the first modem 110 where it could cause errors or damage. The amount of leakage will depend on the frequency cut off and rate of the filters in the diplexer, and in an ideal design there will be no leakage.

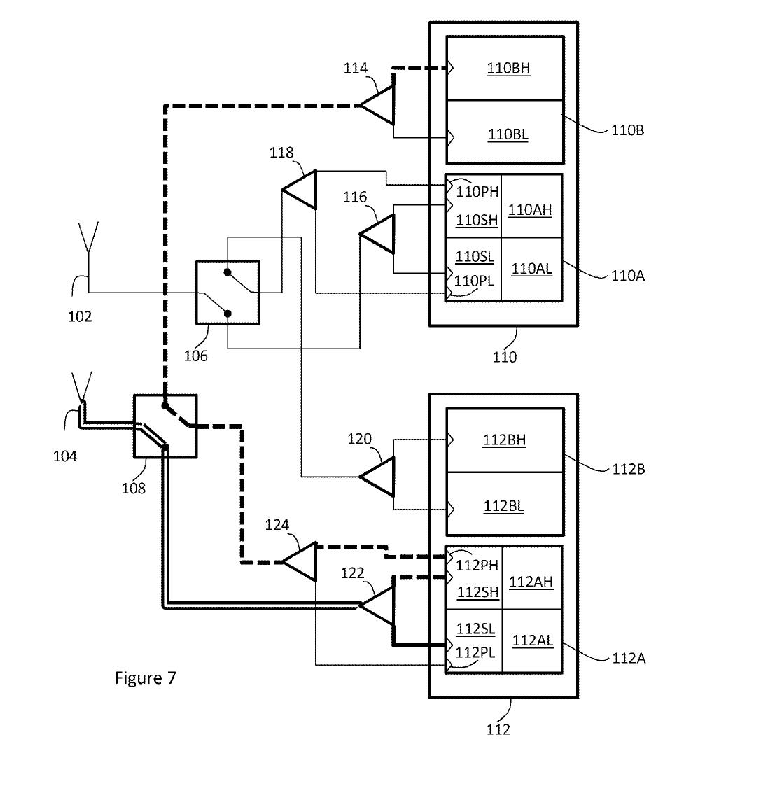

FIG. 7 is a diagrammatic representation of alternative signal paths in the embodiment of FIG. 2 when both the first and second modems 110,112 are operational and the first modem 110 is sharing the second antenna 104 with the second modem 112. In this case the second antenna 104 is shared so that the higher frequency signals are used by the first modem 110 and the lower frequency signals are used by the second modem 112. The controller 126 activates the higher frequency pass through output 112PH of switch 112SH. This directs the higher frequency signal to the higher frequency portion 110BH of the secondary portion 110B of the first modem 110. The first modem 110 can therefore operate for example in a diversity mode using higher frequency signals and the second modem 112 can operate without diversity using lower frequency signals. As discussed above, in some embodiments the controller 126 can deactivate the pass through output 112PH when the second modem 112 is transmitting.

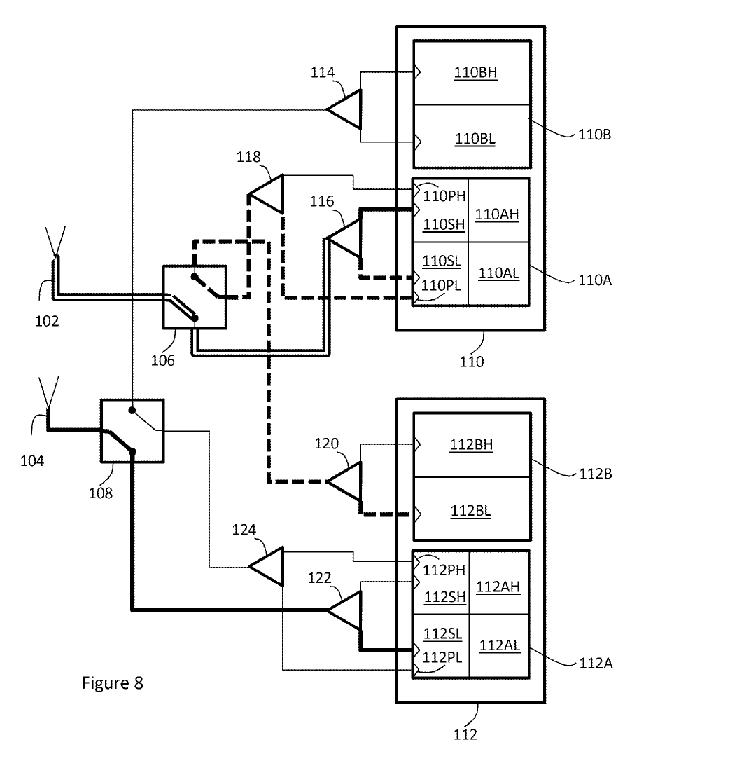

FIG. 8 is a diagrammatic representation of signal paths in the embodiment of FIG. 2 when both the first and second modems 110,112 are operational and the second modem 112 is sharing the first antenna 102 with the first modem 110. In this case the first antenna 102 is shared so that the higher frequency signals are used by the first modem 110 and the lower frequency signals are used by the second modem 112. The controller 126 activates the pass through output 110PL of switch 110SL to direct the lower frequency signals to the lower frequency portion 112BL of the secondary portion 112B of the second modem 112 via diplexer 118, switch 106 and diplexer 120. The second modem 112 can therefore for example operate in a diversity mode using lower frequency signals and the first modem 110 can operate without diversity using higher frequency signals. As discussed above, in some embodiments the controller 126 can deactivate the pass through output 110PL when the second modem 112 is transmitting.

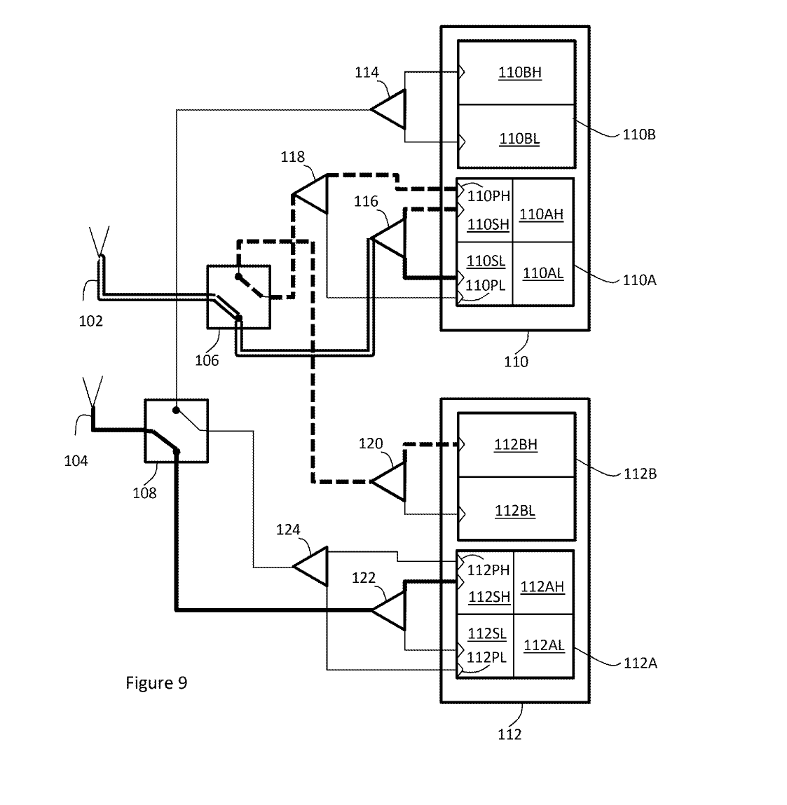

FIG. 9 is a diagrammatic representation of alternative signal paths in the embodiment of FIG. 2 when both the first and second modems 110,112 are operational and the second modem 112 is sharing the first antenna 102 with the first modem 110. In this case the first antenna 102 is shared so that the lower frequency signals are used by the first modem 110 and the higher frequency signals are used by the second modem 112. The controller 126 activates the pass through output 1100PH of switch 110SH to direct the higher frequency signals to the higher frequency portion 112BH of the secondary portion 112B of the second modem 112 via diplexer 118, switch 106 and diplexer 120. The second modem 112 can therefore for example operate in a diversity mode using higher frequency signals and the first modem 110 can operate without diversity using lower frequency signals. As discussed above, in some embodiments the controller can deactivate the pass through output 110PH when the second modem 112 is transmitting.

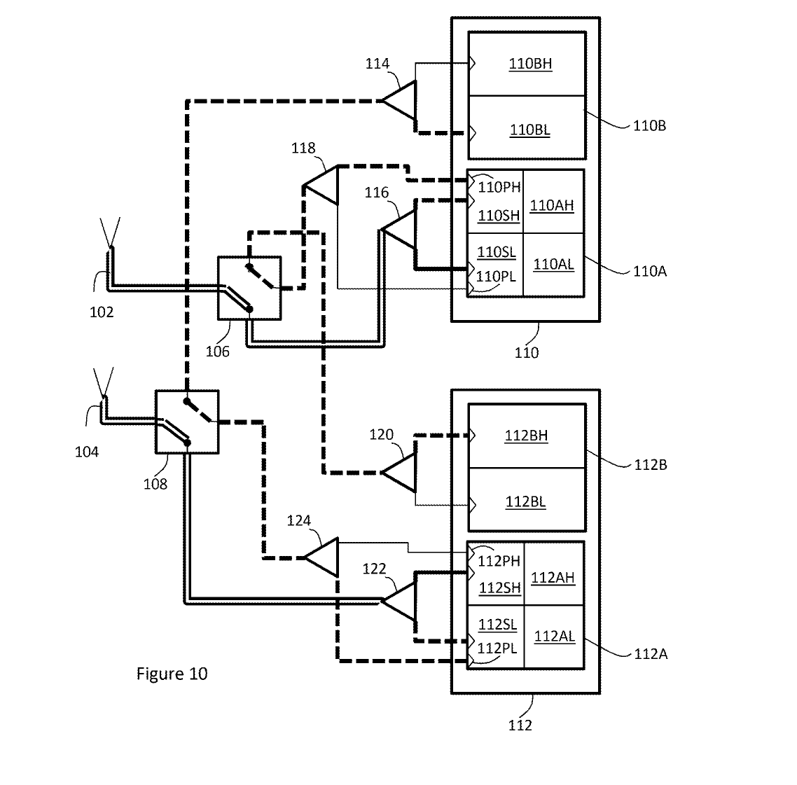

FIG. 10 is a diagrammatic representation of signal paths in the embodiment of FIG. 2 when both the first and second modems 110,112 are operational and the first modem 110 is sharing both the first and second antennas 102,104 with the second modem 112. In this case the first modem 110 is using lower frequency signals and the second modem 112 is using higher frequency signals. The controller 126 activates the higher frequency pass through output 110PH of switch 110SH in the first modem 110 and the lower frequency pass through output 112PL of switch 112SL in the second modem 112. Signals received from the first antenna 102 are split into higher and lower frequency components by diplexer 116. The higher frequency component is then directed to the higher frequency portion 112BH of the secondary portion 112B of the second modem 112 via diplexer 118, first switch 106 and diplexer 120. Likewise, signals received from the second antenna 104 are split into higher and lower frequency components by diplexer 122. The lower frequency component is then directed to the lower frequency portion 110BL of the secondary portion 110B of the first modem 110 via diplexer 124, second switch 108 and diplexer 114. The first modem 110 can therefore for example operate in a diversity mode using lower frequency signals and the second modem 112 can operate for example in a diversity mode using higher frequency signals. As discussed above, in some embodiments the controller 126 can deactivate the pass through output 110PH associated with the first modem 110 when the first modem is transmitting and deactivate the pass through output 112PL associated with the second modem 112 when the second modem 112 is transmitting.

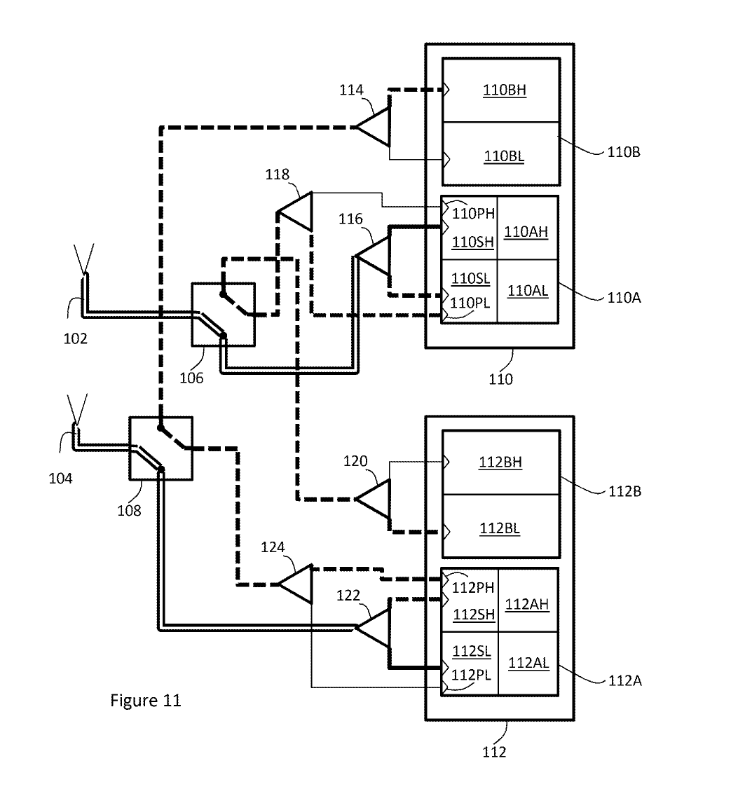

FIG. 11 is a diagrammatic representation of alternative signal paths in the embodiment of FIG. 2 when both the first and second modems 110,112 are operational and the first modem 110 is sharing both the first and second antennas 102,104 with the second modem 112. In this case the first modem 110 uses higher frequency signals and the second modem 112 uses lower frequency signals. The controller 126 activates the lower frequency pass through output 1100PL of switch 110SL in the first modem 110 and the higher frequency pass through output 112PH of switch 112HL in the second modem 112. Signals received from the first antenna 102 are split into higher and lower frequency components by diplexer 116. The lower frequency component is then directed to the lower frequency portion 112BL of the secondary portion 112B of the second modem 112 via diplexer 118, first switch 106 and diplexer 120. Likewise, signals received from the second antenna 104 are split into higher and lower frequency components by diplexer 122. The higher frequency component is then directed to the higher frequency portion 110BH of the secondary portion 110B of the first modem 110 via diplexer 124, second switch 108 and diplexer 114. The first modem 110 can therefore for example operate in a diversity mode using higher frequency signals and the second modem 112 can operate for example in a diversity mode using lower frequency signals. As discussed above, in some embodiments the controller 126 can deactivate the pass through output 110PL associated with the first modem 110 when the first modem is transmitting and deactivate the pass through output 112PH associated with the second modem 112 when the second modem 112 is transmitting.

In another embodiment, the embodiment of FIG. 2 can include additional elements in each TRX switch 110SH, 110SL, 112SH, 112SL so that, when operated as explained above with reference to FIG. 10 or 11, both Modem 1 and Modem 2 use inter band carrier aggregation. For example, each TRX switch can be extended to allow it to connect two nodes, or include dual filters, duplexed duplexers or diplexers.

In still further embodiments, the first modem can include a dual interface for SIM cards, to allow dual SIM operations. In other embodiments, the first modem and the second modem each have their own interface for a SIM card.

Examples of embodiments of the present invention can therefore be operated to allow two modems to share an antenna simultaneously when required by the operating mode. A controller uses information on the operation state of both the first and second modem to control the switch system and pass through outputs. The antenna count is reduced. When only one modem is operating, or two modems are operating with a single antenna (the cases of FIGS. 3 to 5), this embodiment has no additional signal losses from using a dedicated antenna. When an antenna is shared between two modems simultaneously, some additional signal losses are introduced. Table 1 below summarises the additional loses for signals of carrier frequencies of 1 GHz and 2 GHz.

TABLE 1
Additional Losses when an antenna is shared

| | Additional Insertion | Additional Insertion |
|---|---|---|
| Additional Element | Loss @ 1 GHz (dB) | Loss @ 2 GHz (dB) |
| Pass through TRX Switch | 0.3 | 0.3 |
| Diplexer | 0.4 | 0.5 |
| Diplexer | 0.4 | 0.5 |
| RX Switch | 0.5 | 0.6 |
| Total | 1.6 | 1.9 |

The additional losses are same for all the shared antenna embodiments because the signal passes through elements of the same type (although not necessarily the same elements). To give an example using the operation mode of FIG. 11, the secondary portion 110B of the first modem 110 receives a signal which additionally travels via the pass through output of the second modem 112SH, diplexer 124, diplexer 114 and will then require further switching within the secondary portion 110B of the first modem 110. (The signal also passes through switch 108, but this introduces substantially no losses.) Likewise, the secondary portion 112B of the second modem 112 receives a signal which additionally travels via the pass through output of the first modem 100SL, diplexer 118, diplexer 120 and will then require further switching within the secondary portion 112B of the second modem 112.

Table 1 shows that the additional losses due to a sharing antenna in this embodiment are relatively small, around 1.6 dB at 1 GHz and 1.9 dB at 2 GHz.

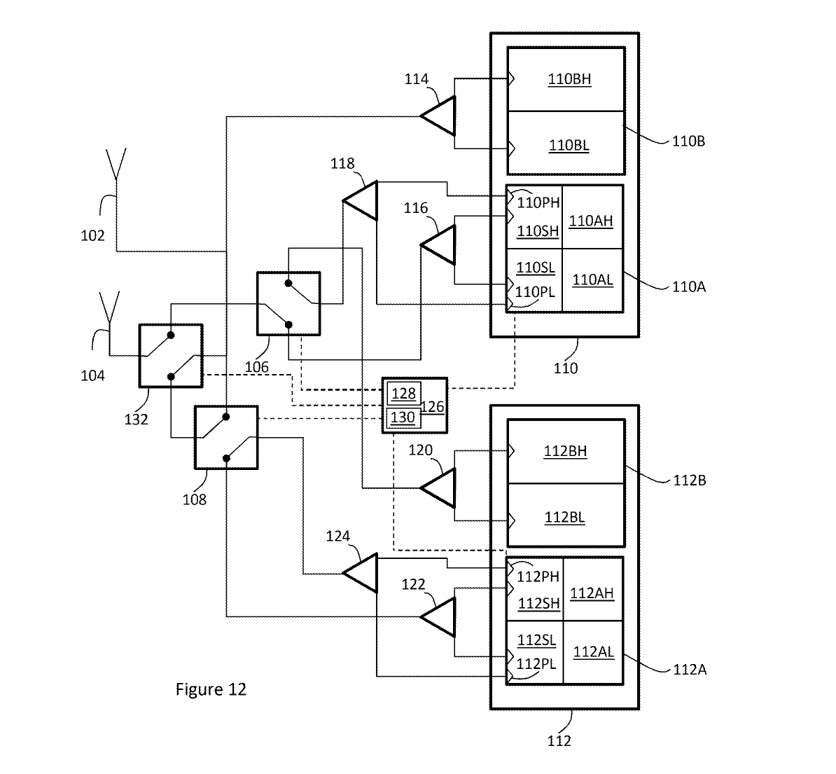

A further embodiment is depicted in FIG. 12. The construction of this embodiment is the same as the embodiment of FIG. 2, except that the switch system includes a third switch 132 connected between the first and second antennas 102,104 and the first and second switches 106,108. The third switch 132 is constructed in the same way as the first and second switches 106, 108. It allows the connection to the first and second antennas 102,104 to be transposed. When the third switch 132 is in the first position (not shown), the first antenna 102 is connected to the first switch 106 and the second antenna 104 is connected to the second switch 108 as in the embodiment of FIG. 2. When the third switch 132 is in the second position (as depicted in FIG. 12), the first antenna 102 is connected to the second switch 108 and the second antenna 104 is connected to the first switch 106. This allows the primary portions 110A,110B of the modems 110,112 to be connected to either the first antenna 102 or the second antenna 104.

Although at least some aspects of the embodiments described herein with reference to the drawings include computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may include a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), etc. The chip or chips may include circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

The above embodiments are to be understood as illustrative examples of the invention. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An apparatus comprising:
a first modem;
a second modem;
a switch system arranged to selectively connect one of the first and second modems to a first antenna and selectively connect one of the first and second modems to a second antenna; and
a pass through output associated with the first modem and arranged to selectively output at least a portion of a received signal to the second modem.

2. The apparatus according to claim 1, wherein the switch system is arranged to connect the pass through output associated with the first modem to the second modem when the first modem is connected to a said first antenna.

3. The apparatus according to claim 1, further comprising a pass through output associated with the second modem and arranged to selectively output at least a portion of a received signal to the first modem.

4. The apparatus according to claim 3, wherein the switch system is arranged to connect the pass through output associated with the second modem to the first modem when the second modem is connected to a said first antenna.

5. The apparatus according to claim 3, wherein the pass through output associated with the second modem comprises a higher frequency output and a lower frequency output; and the apparatus further comprises:
a frequency selective component with a higher frequency port connected to the higher frequency output, a lower frequency port connected to the lower frequency output and a common port arranged to be selectively connected to the first modem, thereby to provide a single output for both the higher frequency output and the lower frequency output.

6. The apparatus according to claim 1 wherein the first modem comprises a higher frequency input/output and a lower frequency input/output; and the apparatus further comprises:
a frequency selective component with a higher frequency port connected to the higher frequency input/output, a lower frequency port connected to the lower frequency input/output and a common port arranged to be selectively connected to a said first antenna, thereby to provide a single input/output to both the higher frequency input/output and the lower frequency input/output.

7. The apparatus according to claim 6, wherein the frequency selective component comprises one of a diplexer, a triplexer and a quadplexer.

8. The apparatus according to claim 1, wherein the pass through output associated with the first modem comprises a higher frequency output and a lower frequency output; and the apparatus further comprises:
a frequency selective component with a higher frequency port connected to the higher frequency output, a lower frequency port connected to the lower frequency output and a common port arranged to be selectively connected to the second modem, thereby to provide a single output for both the higher frequency output and the lower frequency output.

9. The apparatus according to claim 1 wherein the second modem comprises a higher frequency input/output and a lower frequency input/output; and the apparatus further comprises:
a frequency selective component with a higher frequency port connected to the higher frequency input/output, a lower frequency port connected to the lower frequency input/output and a common port arranged to be selectively connected to a said second antenna, thereby to provide a single input/output to both the higher frequency input/output and the lower frequency input/output.

10. The apparatus according to claim 1, wherein:
the first modem comprises a primary portion and a secondary portion;
the second modem comprises a primary portion and a secondary portion; and
the switch system is arranged to selectively connect the primary portion of the first modem or the secondary portion of the second modem to a said first antenna and selectively connect the primary portion of the second modem or the secondary portion of the first modem to a said second antenna.

11. The apparatus according to claim 10, wherein the pass through output associated with the first modem is arranged to selectively output at least a portion of a received signal to the secondary portion of the second modem.

12. The apparatus according to claim 10, further comprising a pass through output associated with the second modem and arranged to selectively output at least a portion of a received signal to the first modem; wherein the pass through output associated with the second modem is arranged to selectively output at least a portion of a received signal to the secondary portion of the first modem.

13. The apparatus according to claim 1, further comprising a controller configured to operate the switching network to
connect the first modem to a said first antenna when the first modem is in operation, and otherwise connect the second modem to the said first antenna; and
connect the second modem to a said second antenna when the second modem is in operation, and otherwise connect the first modem to the said second antenna.

14. The apparatus according to claim 1, further comprising a controller configured to activate or deactivate the pass through output associated with the first modem dependent upon data of an operation state of the second modem.

15. The apparatus according to claim 14, wherein the controller is configured to activate or deactivate the pass through output associated with the first modem dependent upon data of an operation state of the first modem.

16. An apparatus according to claim 1, comprising a controller configured to activate or deactivate the pass through output associated with the second modem dependent upon data of an operation state of the first modem.

17. The apparatus according to claim 16, wherein the controller is configured to activate or deactivate the pass through output of the second modem dependent upon data of the operation state of the second modem.

18. A method of sharing a first antenna and a second antenna between a first modem and a second modem, the method comprising:
connecting the first antenna to the first modem when the first modem is in operation, otherwise connecting the first antenna to the second modem;
connecting the second antenna to the second modem when the second modem is in operation, otherwise connecting the second antenna to the first modem; and
selectively passing at least a portion of a signal received at the first antenna to the second modem through a pass through arrangement associated with the first modem, when the first antenna is connected to the first modem.

19. The method according to claim 18, wherein at least one of:
further comprising the step of selectively passing at least a portion of a signal received at the second antenna to the first modem through a pass through arrangement associated with the second modem, when the second antenna is connected to the second modem; and
wherein the selectively passing at least a portion of a signal received at the first antenna to the second modem is dependent upon an operation state of the first modem and the second modem.

20. The method according to claim 19, wherein:
the selectively passing at least a portion of a signal received at the second antenna to the first modem is dependent upon an operation state of the first modem and the second modem.
